(19) United States
(12) Patent Application Publication
(10) Pub. No.: US 2019/0359458 A1
(43) Pub. Date: Nov. 28, 2019

(54) METHOD OF CONTROLLING A VEHICLE ASSISTANCE EQUIPMENT TO FACILITATE AN OCCUPIED WHEELCHAIR HANDLING AND THE ASSISTANCE EQUIPMENT FOR THE IMPLEMENTATION OF THIS METHOD

(71) Applicant: API CZ s.r.o., Slapy (CZ)

(72) Inventors: Miroslav BARTOS, Tabor (CZ); Jiri Svec, Drazice (CZ)

(21) Appl. No.: 16/120,465

(22) Filed: Sep. 4, 2018

(30) Foreign Application Priority Data
May 28, 2018 (EP) 18174470.7

(51) Int. Cl. B66D 1/58; B66D 1/12; B66D 1/48

(52) U.S. Cl. CPC B66D 1/58; B66D 2700/0141; B66D 1/485; B66D 1/12

(57) ABSTRACT

The vehicle assistance equipment to facilitate an occupied wheelchair (1) handling comprises a control unit (5) and at least one electrically operated winch (3) to whose strap (2) the occupied wheelchair (1) is fastened. The occupied wheelchair (1) is loaded into the vehicle or unloaded out of the vehicle using a drive-up ramp (4) of the vehicle where the winch (3) applies a force to the occupied wheelchair (1) via the strap (2) during the occupied wheelchair (1) handling to facilitate the handling. The parameters of the winch (3) operation continuously change with the changing length of the pulled out strap (2) where the monitored instantaneous load applied to the winch (3) is compared to safe limit values for load for the current position of the occupied wheelchair (1).

### FIELD OF THE INVENTION

The subject of the invention is a method of controlling a vehicle assistance equipment fitted with a drive-up ramp designed for an occupied wheelchair loading and unloading. The assistance equipment comprises a winch with a strap integrated in the vehicle to facilitate the occupied wheelchair handling during loading and unloading.

### BACKGROUND OF THE INVENTION

There are inventions concerning the loading and unloading of an occupied wheelchair using a drive-up ramp the vehicle is fitted with. An example of such a solution is an invention disclosed in the European patent EP 2 293 755. A disadvantage of the solution is that it requires a considerable effort to be put into overcoming the inclined plane of the ramp while handling an occupied wheelchair. Among commonly occurring situations are those when a subtle person lacking sufficient physical strength to load an occupied wheelchair assists in loading it.

To remove the aforementioned disadvantages related to the absence of strength needed for loading an occupied wheelchair assistance systems based on winches powered by electric motor have been designed. Prior to loading an occupied wheelchair the strap is unwound from the winch and pulled out of the vehicle to be fastened to the wheelchair structure with a hook. Then the winch powered by electric motor is activated. The winch is controlled by the control system integrated in the vehicle. Alternatively, a wire based or wireless remote control can be used. An example of such a solution is disclosed in the document WO 2017/205696.

The disadvantages of the known assistance systems with a winch used to facilitate loading and unloading an occupied wheelchair include: In the case of controllers integrated in the vehicle, the assisting person does not have full control over the wheelchair loading. There is a risk of locking the wheels (e.g. by a carry-on object, handbag, umbrella, etc.) and of a fall or wheelchair accident. If the assistance system is equipped with a remote control, the loading of an occupied wheelchair can be controlled directly by the person sitting in the wheelchair. In such a case, the person cannot completely adjust the wheelchair movement direction on their own or hold, for example, a handbag, coat, etc. In addition, there is a risk that the remote control is lost from the vehicle or even gets stolen.

The purpose of the invention is to provide a method of controlling a vehicle assistance equipment to facilitate an occupied wheel chair handling when being loaded into the vehicle or unloaded out of the vehicle which would not require an active use of a remote control by the assisting person or the person sitting in the wheelchair when handling an occupied wheelchair. The method should include automatic safety actions taken to interrupt the winch operation and it should be easily integrable into vehicles as well. In addition, the purpose of the invention includes the provision of assistance equipment for the implementation of the method.

### SUMMARY OF THE INVENTION

The set goal has been resolved by inventing the method of controlling a vehicle assistance equipment and designing the vehicle assistance equipment according to the below mentioned invention.

Within the framework of the implementation of the method of controlling the vehicle assistance equipment to facilitate an occupied wheelchair handling the free end of a strap of at least one winch being a component of the assistance equipment is fastened to the occupied wheelchair. Then the occupied wheelchair is loaded into the vehicle or unloaded out of the vehicle, namely by riding the occupied wheelchair along a drive-up ramp which the vehicle is equipped with. During the occupied wheelchair handling the winch applies a force on the occupied wheelchair via the strap and facilitates the handling.

The essence of the invention rests in the fact that the control unit is first entered safe limit values for loads applied to the winch that correspond to at least the weight of the wheelchair with the person sitting in it and/or the torque necessary for pulling the wheelchair with the person sitting in it into the vehicle. Different torques are needed prior to entering the drive-up ramp, during riding along the drive-up ramp and when moving inside the vehicle. After fastening the free end of the strap to the occupied wheelchair, the system for the monitoring of load applied to the winch is activated. Subsequently, the strap is pre-tensioned and kept working until the strap resistance exceeds the monitored tension limit value. Once the strap is pre-tensioned, the length of the strap pulled away from the winch towards its free end is determined. The length is determined after tensioning the strap to prevent the length of the pulled out end thereof from being distorted by, for example a fold on the pulled out strap. Then the winch is activated. Its parameters change continuously with the changing length of the pulled out strap and the monitored load applied to the winch is compared to the limit values for load in the current position of the occupied wheelchair determined according to the length of the pulled out strap. If the safe limit values for the winch load are exceeded, the parameters of the winch operation are changed or its operation suspended.

Considering the fact that the depth of the cargo space and the length of the drive-up ramp are constant, it is possible to determine the position of the occupied wheelchair according to the length of the pulled out strap, either at the level of the cargo space or on the ground, or on the inclined plane of the drive-up ramp, and apply correct safe limit values for the winch load accordingly. If the load applied to the winch exceeds the safe limit value, the winch operation is stopped or the parameters of its operation are adjusted. The person in the wheelchair or the assisting person can control the process of the occupied wheelchair handling upon loading or unloading by a mere holding the occupied wheelchair handles or wheel tyres and stopping it completely where necessary.

If the strap fastening has not been successful, the winch, at the attempt to pre-tension the strap, winds up the strap, by which the strap will get prepared for a new use.

It is preferred if there are time delays between fastening the free end of the strap to the occupied wheelchair, strap pre-tensioning and winch operation starting. The time delays provide the person sitting in the wheelchair as well as the assisting person with comfort and improve safety related to handling an occupied wheelchair. The time delays can last seconds to tens of seconds as necessary.

Preferably, the monitoring of the instantaneous load applied to the winch (3) is performed by any of the following ways:
detection of the winch electric motor current consumption,
detection of the winch electric motor revolutions,
detection of the winch electric motor torque.

The aforementioned measured values have variable behaviour along the wheelchair trajectory, or where applicable within the strap extension, depending on the weight of the wheelchair with the person sitting in it, the angle of the drive-up ramp and other parameters. Individual positions of the wheelchair can be changed by the length of the strap extension from the winch. The safe limit values of load applied to the winch can be set for individual positions by a potentiometer or a different control element in the control unit in advance and saved therein. During monitoring the control unit receives the information on exceeding the safe limit value for load applied to the winch in any of the saved positions. This may be simulated by, for example, the purposeful application of the brake by the person sitting in the wheelchair or by the assisting person. The control unit correspondingly reduces the current and tension of the winch electric motor, or stops it completely where necessary. When the load drops under the safe limit value, which may be attained, for example, by the assisting person pushing the wheelchair, the control unit reactivates the winch operation. If the assistance equipment is fitted with an optical sensor or a different sensor for detecting the winch revolutions, such movements are controlled by the control unit based on a signal from the sensor.

Preferably, the length of the pulled out strap is monitored by detecting the number of the winch revolutions. Detecting the number of the winch revolutions is preferably calibrated by winding up the strap up to its free end onto the winch and subsequent resetting the detected number of revolutions. Depending on the number of the winch revolutions, the length of the pulled out strap can be easily calculated based on the knowledge of the winch perimeter length.

In addition, the invention comprises the vehicle assistance equipment to facilitate an occupied wheelchair handling that utilizes the invented method of control without a remote control used by the assisting person or the person sitting in the wheelchair.

The assistance equipment consists of at least one winch with a strap applying a force to an occupied wheelchair and a control unit to control the operation of the winch where the vehicle is fitted with a drive-up ramp for the occupied wheelchair in addition to the assistance equipment.

The essence of the invention rests in the fact that the winch is equipped with the first monitoring element to monitor load applied to the winch that is connected in a manner allowing signals to be transmitted to the control unit. In addition, the winch is fitted with the second monitoring equipment to monitor the length of the pulled out strap that is connected to the control unit in a way allowing signal transmission. The control unit is fitted with at least one data repository with an uploaded safety software module which stops the operation of the winch if the limit values for load applied to the winch are exceeded. In addition, there is a control software module assessing load applied to the winch, as to whether the load is within the defined limits, and controlling the winch operation according to the position of the occupied wheelchair determined according to the length of the pulled out strap. And last but not least, there is a measuring software module for the determination of the length of the pulled out strap based on pulses from the second monitoring element.

The assistance equipment actively monitors load applied to the winch and also actively monitors the length of the pulled out strap. The software modules include pre-set limit values for load applied to the winch depending on the position of an occupied wheelchair, i.e. whether the wheelchair is on the horizontal plane of the cargo space or on the ground or on the inclined plane of the drive-up ramp. The position of the occupied wheelchair is determined based on the value of the length of the pulled out strap. No remote control is necessary as the equipment is activated automatically upon fastening the free end of the strap to the wheelchair and upon the expiry of the time delay necessary for fastening. The winch operation is controlled by the assisting person or the person sitting in the wheelchair by mere braking the wheelchair.

In a preferred embodiment of the assistance equipment according to the present invention the safety software module or the control software module include instructions for time delays between fastening the free end of the strap to the occupied wheelchair, the strap pre-tensioning, and the winch operation starting. Such time delays can be set to last seconds to tens of seconds depending on individual needs.

In another preferred embodiment of the present invention the first monitoring element to monitor load applied to the winch consists of a device detecting electric current on the winch drive unit. The electric drive unit that must overcome a certain resistance, caused for example by load, increases the consumption of electric current from the power supply unit. In other preferred alternatives the first monitoring element to monitor load applied to the winch can consist of a device detecting the revolutions and/or torque of the electric motor of the winch. All such embodiments and/or combinations thereof can be used for the monitoring of instantaneous load applied to the winch and comparing such instantaneous load with safe limit values.

Another preferred embodiment comprises the assistance equipment according to the invention where the free end of the strap is equipped with an alarm device for the winch operation stopping that is connected in a way allowing signals to be transmitted to the control unit. The alarm device prevents the complete winding up of the strap onto the winch with the free end becoming unavailable. In addition, the data repository of the control unit comprises a calibration software module for the calibration of the second monitoring element that monitors the length of the pulled out strap. Preferably, the second monitoring element for the monitoring of the length of the pulled out strap comprises at least one optical sensor to count the winch revolutions.

The assistance equipment according to the present invention is preferably equipped with a winch that has at least two rates for the strap unwinding. Preferably, the assistance equipment includes at least one electronically operated safety retractor to safeguard the occupied wheelchair that is connected to the control unit where the data repository of the control unit comprises at least one retractor software module. A mere double-rate winch increases comfort due to the fact that the higher rate is used for pulling the strap out of the winch while the lower rate is used for safe force based assistance when handling the occupied wheelchair.

Among the advantages of the present invention is the absence of control elements as the inventive method and the related assistance equipment work without the necessity to use a remote control. Where necessary the assisting person or the person sitting in the occupied wheelchair himself/herself can intervene by braking the wheelchair. The invention works independently and its architecture allows its smooth application to both new vehicles and the existing vehicles designed for the transport of wheelchairs.

### EXPLANATION OF DRAWINGS

The present invention will be explained in detail by means of the following figures where:

FIG. 1 provides a schematic diagram of the assistance equipment,

FIG. 2 provides a view of the wheelchair before the start of its loading into the vehicle,

FIG. 3 provides a view of the wheelchair when riding up the drive-up ramp,

FIG. 4 provides a view of the wheelchair on the drive-up ramp,

FIG. 5 provides a view of the wheelchair before entry into the transport space of the vehicle,

FIG. 6 provides a view of the wheelchair during entry into the transport space of the vehicle,

FIG. 7 provides a view of the wheelchair in the cargo space of the vehicle,

FIG. 8 provides a view of the graph with an indicated limit value of the maximum load and with a realistic behaviour of forces applied to the winch,

FIG. 9 provides a plan view of the wheelchair before the drive-up ramp.

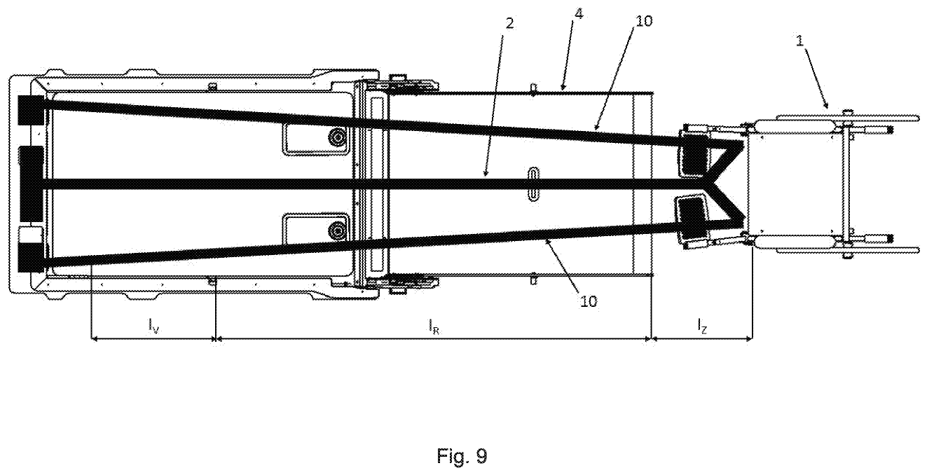

### AN EXAMPLE OF THE INVENTION EMBODIMENT

It shall be understood that the specific cases of the invention embodiments described and depicted below are provided for illustration only and do not limit the invention to the examples provided here. Those skilled in the art will find or, based on routine experiment, will be able to provide a greater or lesser number of equivalents to the specific embodiments of the invention which are described here. Also such equivalents will be included in the scope of the following claims.

The invention concerns assistance equipment designed for vehicles, in particular passenger vehicles, that have been adapted for the transport of an occupied wheelchair 1 in the rear part of the vehicle. An example of such a vehicle can be the Fiat Doblo passenger vehicle whose rear cargo space has been changed into transport space for an occupied wheelchair 1, where the rear part of the vehicle is fitted with a retractable drive-up ramp 4 allowing the occupied wheelchair 1 to be handled during the occupied wheelchair 1 loading and unloading. The drive-up ramp 4 is basically an inclined plane allowing the difference in height between the ground and the floor of the vehicle transport space to be surmounted.

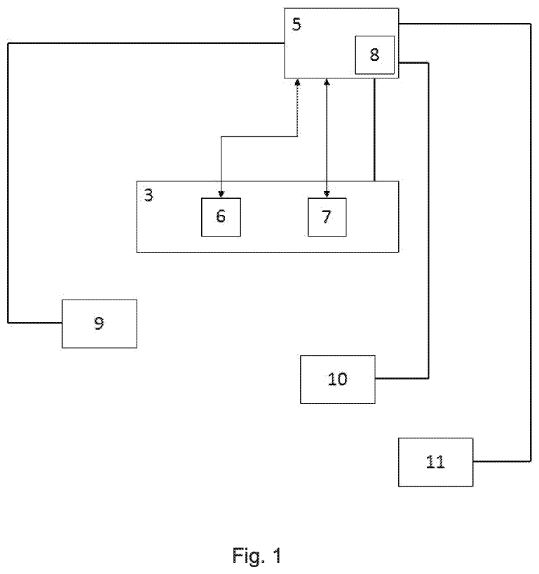

Considering the fact that the inclined plane of the drive-up ramp 4 with the occupied wheelchair 1 is very difficult to surmount either for the person sitting in the wheelchair 1 or the assisting person, the assistance equipment designed to facilitate the problematic power phase of handling has been invented. The assistance equipment consists of a winch 3 that winds up a strap 2 using one of the strap's free ends onto a winding-up drum, shaft, etc. The strap 2 refers to a textile strap, that is non-elastic, i.e. with a constant length and resistant to mechanical damage, such as abrasion. At its free end the strap 2 is fitted with an element for fastening to the occupied wheelchair 1, for example, a snap hook. Once the strap 2 is duly fastened, the operation of the winch 3 is activated and its strength facilitates the occupied wheelchair 1 handling particularly along the inclined plane of the drive-up ramp 4. In addition, the assistance equipment consists of a control unit 5 that controls the operation of the assistance equipment. The control unit 5 consists of, for example, an integrated computer or microcomputer, a combination of logic circuits, a combination of analog circuits, etc. to be able to receive signals from connected electronic elements, to be able to process the received signals using the software modules uploaded into its data repository 8 comprised, e.g. by a flash memory, and to be able to generate control signals for the connected electronic elements. A schematic representation of an example of such assistance equipment is provided in FIG. 1.

The winch 3 is fitted with the first monitoring element 6 to monitor load applied to the winch 3. The first monitoring element 6 is connected to the control unit 5 on a wire basis. The first monitoring element 6 in one example of the invention embodiment consists of an ammeter and is connected to the power supply distribution system of the electrical drive unit of the winch 3. The current consumption, based on which the degree of load applied to the winch 3 can be calculated changes with instantaneous load applied to the winch 3. The calculation is made on a software basis by the programme integrated in the control software module for the assessment of load applied to the winch 3. Information on load applied to the winch 3 is monitored on a continuous basis.

In another example the first monitoring element 6 to monitor load applied to the winch 3 consists of an optical sensor detecting the revolutions of the winch 3. If the load applied to the winch 3 increases above the pre-set safe limit value, this situation will be demonstrated by a corresponding decrease in the winch 3 revolutions. The control unit 5 will received this item of information and can consequently change the operation parameters of the winch 3 or stop it completely. Reactivation of the winch 3 operation is performed as soon as the optical sensor detects the movement of the wheelchair 1 where such a movement is induced by the person sitting in the wheelchair or by the assisting person.

In another example of the present invention embodiment the first monitoring element 6 can consist of a device detecting the torque of the winch 3 electric motor.

The winch 3 is also fitted with the second monitoring element 7 to monitor the length of the pulled out strap 2 that is connected to the control unit 5 on a wire basis. At the same time the free end of the strap 2 is fitted with an alarm device 9 to stop the operation of the winch 3 that is connected to the control unit 5 on a wire basis. The alarm device 9 consists of, for example, a mechanical stop which, when the entry opening of the strap 2 reaches the winch 3, increases the load applied to the winch 3 in a step manner, which will result in the winch 3 operation switching off. Alternatively, the alarm device consists of an electronic passive wireless transponder that generates a signal for the control unit 5 to stop the operation of the winch 3. A person skilled in the field of automation will be able to employ other equivalent solutions. The second monitoring element 7 can consist of, for example, a light barrier dragged by the rotating part of the winch 3, e.g. a winding drum, shaft, etc., where every revolution of the rotating part is assigned a length of the strap wound up onto/unwound from the winch 3. The length of the strap is determined depending on the number of revolutions of the rotating part of the winch 3.

The winch 3 can be fitted with a clutch for disconnecting the drive unit of the winch 3, or with a multi speed gearbox allowing a higher speed of the strap 2 unwinding to be attained during manual unwinding towards the occupied wheelchair 1, and vice versa, a consequent decrease in the speed of the strap 2 winding when facilitating the occupied wheelchair 1 handling.

The assistance equipment includes electronically controlled safety retractors 10 securing the occupied wheelchair 1. To prevent the wheelchair 1 from riding away from the drive-up ramp 4, the wheelchair is safeguarded by safety retractors 10. The retractors 10 are electronically controlled by the control unit 5 to become unlocked in the case of the wheelchair 1 assisted leaving the vehicle via the drive-up ramp 4 to the ground. Signals for the retractors 10 are generated using the retractor software module uploaded to the data repository 8 of the control unit 5.

The data repository 8 of the control unit 5 comprises a safety software module whose task is to continuously compare load applied to the winch 3 with the instantaneously allowed load and if the limit values are exceeded to stop the operation of the winch 3 or apply an instruction for a change of the winch 3 operation parameters. It also includes a control software module whose task is to control the operation of the winch 3 of the assistance equipment. Last but not least, the control unit 5 in its data repository 8 comprises an uploaded software module processing signals from the second monitoring element 7 and determining the length of the pulled out part of the strap 2. The measuring software module is completed by a calibration software module that resets the data on the length of the pulled out part of the strap 2 upon every complete winding up of the strap 2 for calibration purposes.

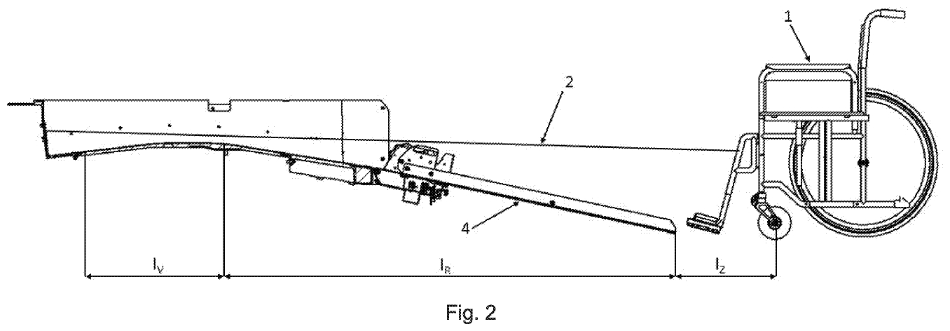

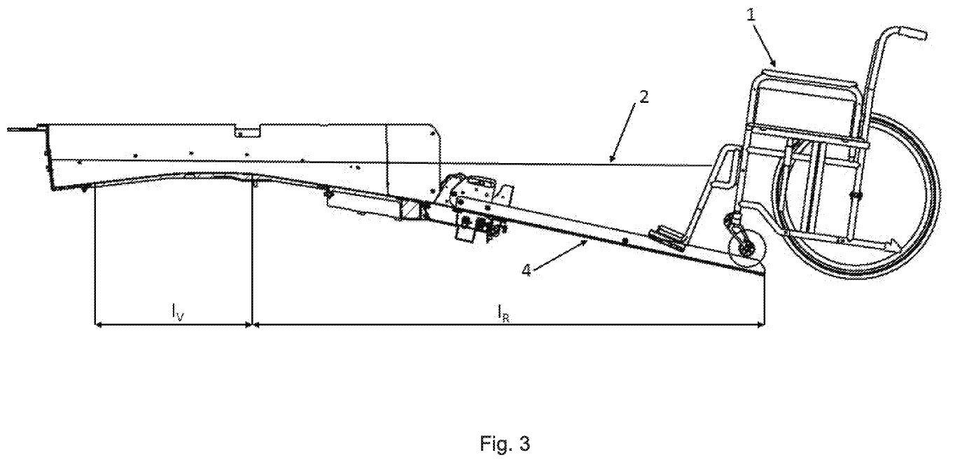

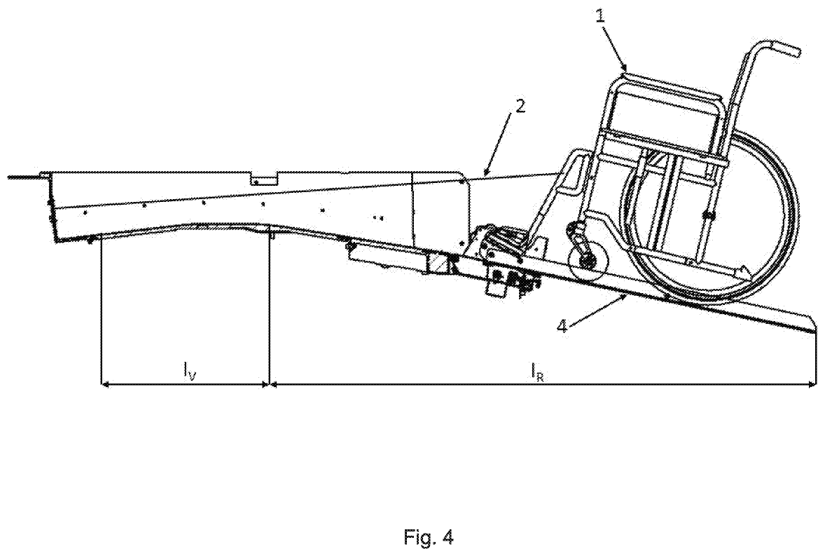

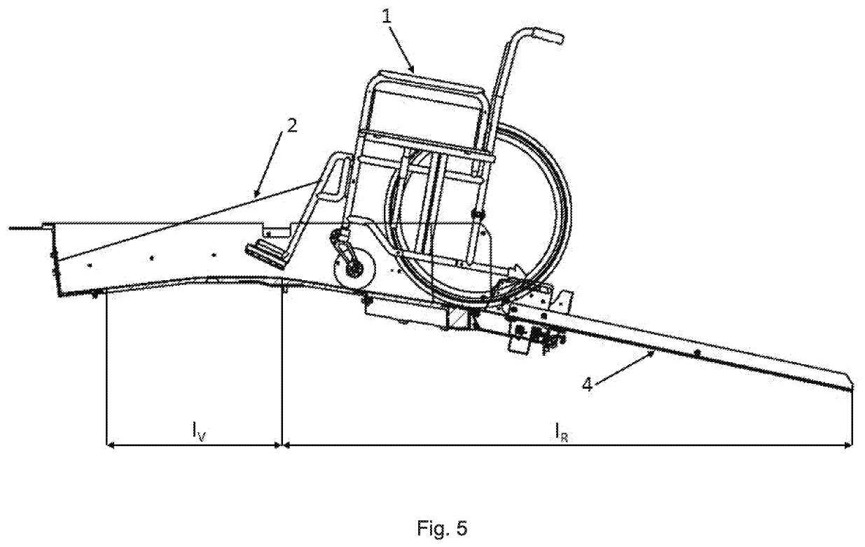

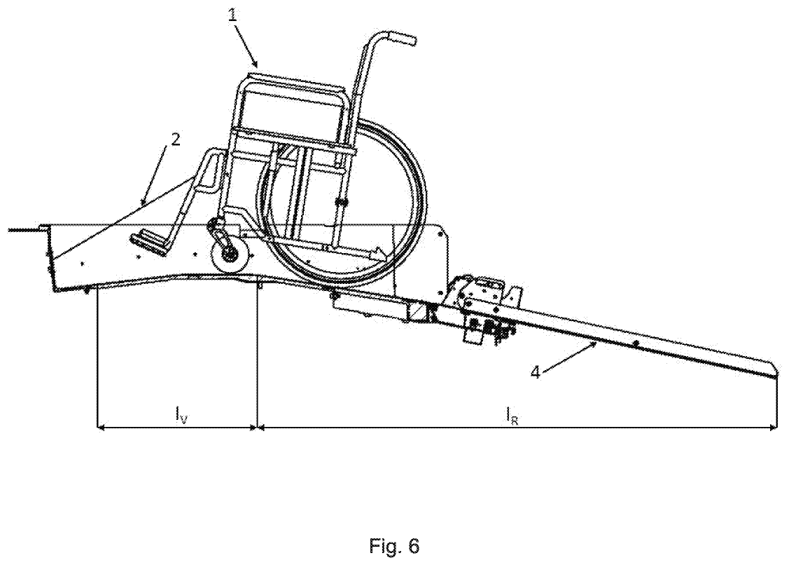

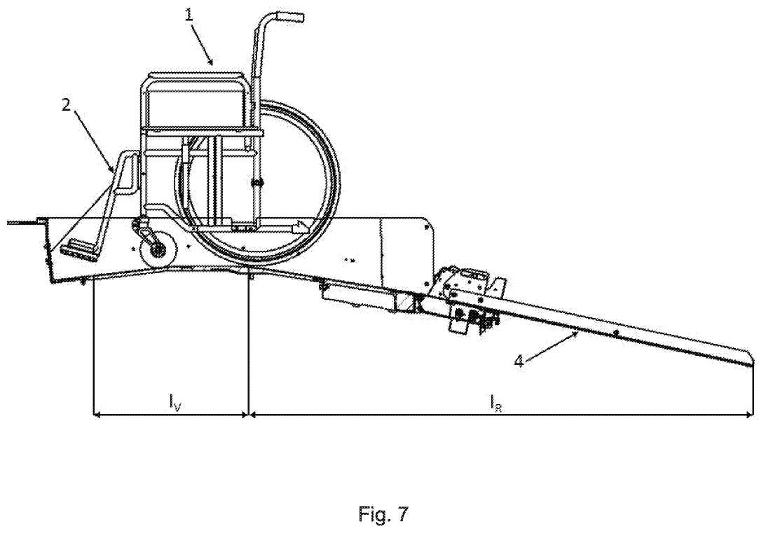

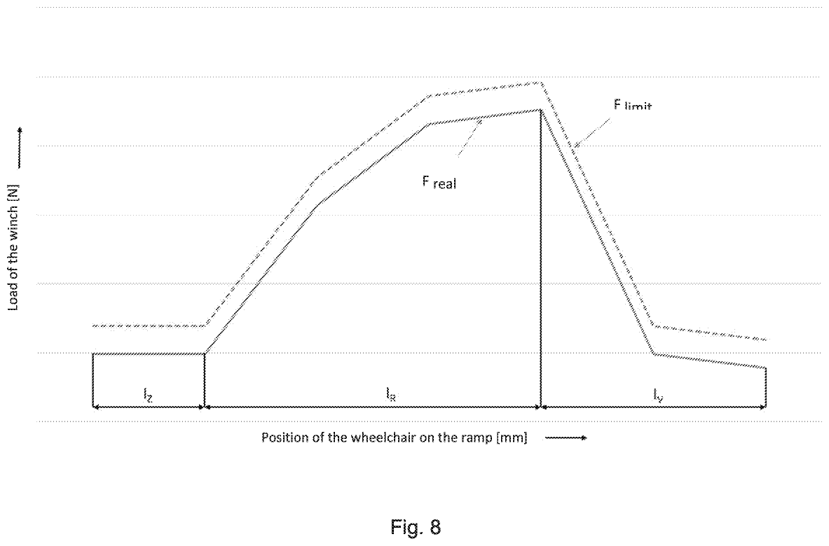

FIG. 2 through 7 show the consecutive phases of handling related to the wheelchair 1 loading into the vehicle. The assistance equipment works in the following steps. At first the free end of the strap 2 is attached to the occupied wheelchair 1 using a hook. After a safety delay lasting for example 5 seconds, the winch 3 is activated to pre-tension the strap 2. After pre-tensioning the strap 2 there is another delay lasting 5 s. Then the winch 3 is activated and gradually changes the length of the strap 2 to move the occupied wheelchair 1 along. With the changing length of the strap 2 the control software module recalls the parameters of the winch 3 operation as the load applied to the strap 2 is changing. As it can be seen in FIG. 2, the total length of the pulled out strap 2 can be divided into three portions where the first portion l_{V} corresponds to the level of the vehicle floor, the second portion l_{R} corresponds to the inclined plane of the drive-up ramp 4, and the third portion l_{Z} corresponds to the ground level. If the control unit 5 ascertains that the end of the strap is within the l_{R} portion, the safe limit values for load applied to the winch 3 are increased. The increase is shown in the chart in FIG. 8.

If the strap 2 is not hooked to the occupied wheelchair 1, the strap 2 is winded up to its free end and the operation of the winch 3 is stopped. Subsequently, the measurement of the distance of the pulled out strap 2 is recalibrated.

The variable quantity referring to the weight of the occupied wheelchair 1 is dealt with by the control a safety software modules that include data for pre-defined intervals of permissible weights. For the transport of one particular person sitting in the wheelchair 1, a suitable interval of weights is set on a potentiometer or a different control element 11 and the control unit 5 then works completely automatically. The potentiometer or different control element 11 is installed in the vehicle and connected to the control unit 5.

If the operation of the winch 3, needs to be stopped, the person sitting in the wheelchair 1 or the assisting person can exceed the limit for load applied to the winch 3 by braking the wheelchair 1.

### INDUSTRIAL APPLICABILITY

The method of controlling the vehicle assistance equipment to facilitate an occupied wheelchair handling can be employed in the area of occupied wheelchair transport.

### OVERVIEW OF THE POSITIONS

1 wheelchair

2 strap

3 winch

4 drive-up ramp

5 control unit

6 the first monitoring element

7 the second monitoring element

8 data repository

9 alarm device

10 safety retractor

l_{Z} distance on the ground

l_{R} distance on the drive-up ramp

l_{V} distance in the vehicle

1. The method of controlling a vehicle assistance equipment to facilitate an occupied wheelchair (1) handling, within the framework of which the free end of the strap (2) of at least one electrically operated winch (3) forming a component of the assistance equipment is fastened to the occupied wheelchair (1), then the occupied wheelchair (1) is loaded into a vehicle or unloaded out of the vehicle using a ride of the occupied wheelchair (1) along a drive-up ramp (4) of the vehicle where the winch (3) applies a force to the occupied wheelchair (1) via a strap (2) during handling with the occupied wheelchair (1) and is controlled by a control unit (5) to facilitate the handling characterized in that the following sequence of steps is executed:
a) the control unit (5) is set at least one safe limit value for load applied to the winch (3) corresponding to the weight of the occupied wheelchair (1) and/or at least one safe limit value for load applied to the winch (3) corresponding to the torque necessary for pulling the occupied wheelchair (1) in any point along the length of the strap (2) extension from the winch (3),
b) the free end of the strap (2) is fastened to the occupied wheelchair (1) manually,
c) the control unit (5) activates the monitoring of the instantaneous load applied to the winch (3),
d) the winch (3) pre-tensions the strap (2),
e) the length of the strap (2) extension away from the winch (3) to the free end of the strap (2) fastened to the wheelchair (1) is determined,
f) the control unit (5) activates the winch (3) operation for pulling the occupied wheelchair (1) into the vehicle,
g) during the operation of the winch (3) the control unit (5) compares the instantaneous values of load applied to the winch (3) with the safety limit values for load applied to the winch (3) set in step a),
h) upon exceeding at least one safety limit value for load applied to the winch (3) the control unit (5) adjusts the parameters of the winch (3) operation or stops the winch (3),
i) as soon as the instantaneous value of load applied to the winch (3) returns under the limit value, the control unit (5) adjusts the parameters of the winch (3) operation or reactivates the winch (3) again.

2. The method according to claim 1 characterized in that there is a time delay between step b) fastening the free end of the strap (2) to the occupied wheelchair (1) and step d) the strap (2) pre-tensioning.

3. The method according to claim 1 characterized in that there is a time delay between step d) pre-tensioning of the strap (2) and step f) activation of the winch (3) operation.

4. The method according to claim 1 characterized in that the monitoring of the instantaneous load applied to the winch (3) according to steps a) and g) proceeds by any of the following ways or a combination thereof:
detection of the winch (3) electric motor current consumption, or
detection of the winch (3) electric motor revolutions, or
detection of the winch (3) electric motor torque.

5. The method according to claim 1 characterized in that the length of the strap (2) is monitored by detecting the number of revolutions of the winch (3) when unwinding the strap (2) from the winch (3).

6. The method according to claim 5 characterized in that the detection of the number of revolutions is calibrated by winding the strap (2) up to the free end of the strap (2) with the subsequent resetting the number of detected revolutions.

7. The vehicle assistance equipment to facilitate an occupied wheelchair (1) handling comprising at least one winch (3) with a strap (2) to apply a force to the occupied wheelchair (1) and a control unit (5) to control the operation of the winch (3), where the vehicle is fitted with a drive-up ramp (4) for the occupied wheelchair (1) characterized in that the winch (3) is equipped with the first monitoring element (6) to monitor load applied to the winch (3) connected to the control unit (5) for signal transmission, wherein the winch (3) is also equipped with the second monitoring element (7) to monitor the length of the pulled out strap (2) that is connected to the control unit (5) for signal transmission, where the control unit (5) is also equipped with at least one data repository (8) that comprises a safety software module to stop the operation of the winch (3), a control software module to assess load applied to the winch (3), a control software module to control the operation of the winch (3) and a measuring software module to determine the length of the pulled out strap (2).

8. The assistance equipment according to claim 7 characterized in that the safety software module or the control software module comprises an instruction for a time delay between fastening the free end of the strap (2) to an occupied wheelchair (1) and the strap (2) pre-tensioning.

9. The assistance equipment according to claim 7 characterized in that the safety software module or the control software module comprises an instruction for a time delay between the strap (2) pre-tensioning and the activation of the winch (3) operation.

10. The assistance equipment according to claim 7 characterized in that the first monitoring element (6) to monitor load applied to the winch (3) consists of at least some of the following devices or a combination thereof:
a device for the detection of the winch (3) electric motor current consumption, or
a device for the detection of the winch (3) electric motor revolutions, or
a device for the detection of the winch (3) electric motor torque.

11. The assistance equipment according to claim 7 characterized in that the free end of the strap (2) is fitted with an alarm device (9) to stop the operation of the winch (3) that is connected to the control unit (5) for signal transmission, and in that the data repository (8) of the control unit (5) comprises a calibration software module to calibrate the second monitoring element (7) to monitor the length of the pulled out strap (2).

12. The assistance equipment according to claim 11 characterized in that the second monitoring element (7) to monitor the length of the pulled out strap (2) consists of at least one optical sensor for counting the winch (3) revolutions.

13. The assistance equipment according to claim 7 characterized in that the winch (3) has at least rates of the strap (2) unwinding.

14. The assistance equipment according to claim 7 characterized in that it comprises at least one electronically controlled safety retractor (10) to safeguard the occupied wheelchair (1) that is connected to the control unit (5) where the data repository (8) of the control unit (5) comprises at least one uploaded retractor software module.
